(19) United States
(12) Patent Application Publication
(10) Pub. No.: US 2005/0059344 A1
(43) Pub. Date: Mar. 17, 2005

(54) Accommodation device for bluetooth earphone

(76) Inventor: Chia-Hao Chang, Taipei (TW)

Correspondence Address: BIRCH STEWART KOLASCH & BIRCH, PO BOX 747, FALLS CHURCH, VA, 22040-0747, US

(21) Appl. No.: 10/660,618

(22) Filed: Sep. 12, 2003

(51) Int. Cl. H04B 5/00; H04M 1/00

(52) U.S. Cl. 455/41.1; 455/569.1

(57) ABSTRACT

An accommodation device for a bluetooth earphone is provided on a bluetooth communications apparatus. The accommodation device also connects a power source of the bluetooth earphone to a power source of the bluetooth communication apparatus. Therefore, the bluetooth earphone can be conveniently received in the bluetooth communication apparatus while being charged through the power source of the bluetooth communication apparatus.

### FIELD OF THE INVENTION

The present invention relates to an accommodation device for a bluetooth earphone and, more particularly, to a device making use of a receiving space in a bluetooth communication apparatus to accommodate a bluetooth earphone and simultaneously charge the bluetooth earphone through the bluetooth communications apparatus.

### BACKGROUND OF THE INVENTION

The bluetooth technology is a new open wireless communication standard, and lets desktop and notebook computers, personal digital assistants (PDAs), mobile phones, printers, scanners, digital still cameras and even electric appliances perform wireless short-range connection, with a range of 10 meters. The bluetooth technology has unlimited possibilities. In the not too distant future, photographs taken with a digital still camera will be wirelessly transmittable to a bluetooth mobile phone. With the addition of a few lines of text, the photographs can be made into electronic postcards and sent to relatives and friends via email. A bluetooth car kit can provide a more convenient handsfree function for safer car driving. Even when waiting in an airport lounge, one can print files on the closest printer or send files from a notebook computer to a printer via email. An electronic bluetooth car key on a mobile phone can even open car doors, and credit card information stored in a mobile phone and protected by a password and encryption function can be used to make payment and then receive an electronic receipt.

The bluetooth technology has been applied to wireless communication apparatuses matched with a bluetooth earphone. However, existent bluetooth mobile phones are bulkier while the bluetooth earphone is small. Therefore, the bluetooth earphone is difficult to find after it is stored, and may easily be lost. Besides, when it is necessary to charge the bluetooth earphone, an external power source is required. In particular, two kinds of chargers must be taken when one goes out, which is inconvenient.

### SUMMARY OF THE INVENTION

The primary object of the present invention is to provide an accommodation device for a bluetooth earphone. The accommodation device makes use of a first groove and a second groove of a bluetooth communication apparatus. A first storage battery used by the bluetooth communication apparatus is received in the first groove. The bluetooth earphone is received in the second groove. This structure makes losing the bluetooth earphone more difficult.

Another object of the present invention is to provide an accommodation device for a bluetooth earphone in which the bluetooth earphone is connected to an earphone power source connector of the second groove and a charging device of the bluetooth communication apparatus. Therefore, when the bluetooth communication apparatus is being charged, the bluetooth earphone can be simultaneously charged.

Yet another object of the present invention is to provide an accommodation device for a bluetooth earphone in which the accommodation device provides a single structure that simultaneously charges the bluetooth communication apparatus and the bluetooth earphone, thus reducing the number of necessary chargers and facilitating use.

To achieve the above objects, a bluetooth communication apparatus of the present invention comprises a first groove and a second groove. A storage battery of the bluetooth communication apparatus is received in the first groove. The bluetooth earphone is received in the second groove. Therefore, the bluetooth earphone is easily found after storage because it has a fixed placement position.

Moreover, an earphone charging slot of the bluetooth earphone is connected to an earphone power source connector of the bluetooth communication apparatus. Therefore, when the bluetooth communication apparatus is being charged, a first storage battery of the bluetooth communication apparatus and a second storage battery of the bluetooth earphone can be simultaneously charged.

### BRIEF DESCRIPTION OF THE DRAWINGS

The various objects and advantages of the present invention will be more readily understood from the following detailed description when read in conjunction with the appended drawing, in which:

FIG. 1 is a diagram of a preferred embodiment of the present invention;

FIG. 2 is a structural block diagram of a preferred embodiment of the present invention;

FIG. 3 is an assembly diagram of a preferred embodiment of the present invention; and

FIG. 4 is another assembly diagram of a preferred embodiment of the present invention.

### DETAILED DESCRIPTION OF THE PREFERRED EMBODIMENTS

The present invention makes use of a bluetooth communication apparatus to provide a placement space for a bluetooth earphone for solving the problem of easy loss of the bluetooth earphone in the prior art and accomplishing simultaneous charging of the bluetooth communication apparatus and the bluetooth earphone for solving the prior art drawback of needing two charging cables.

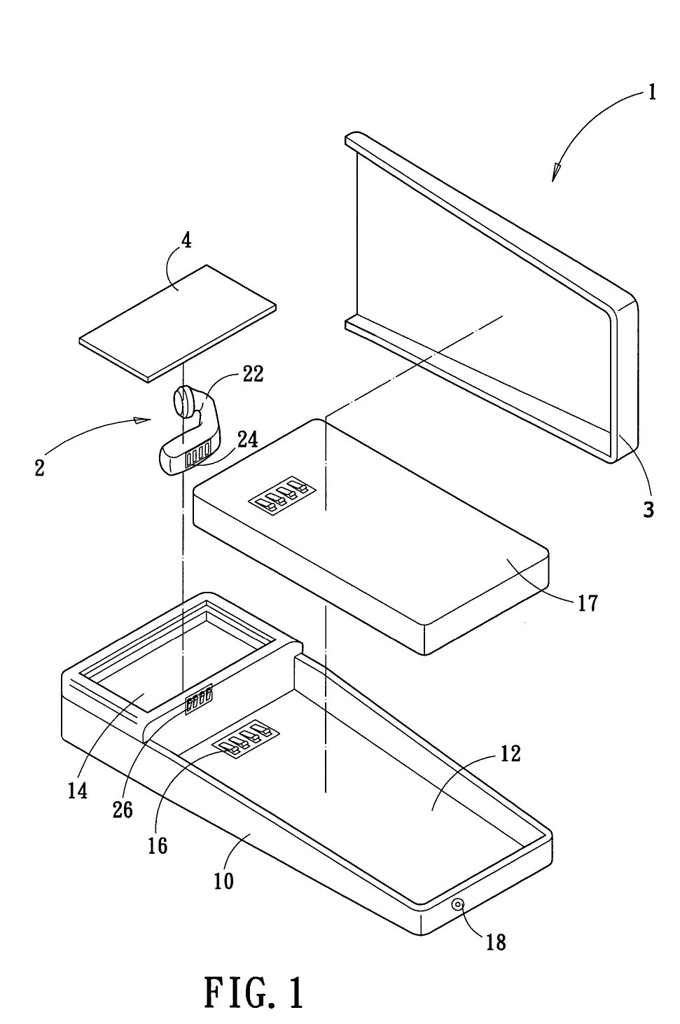

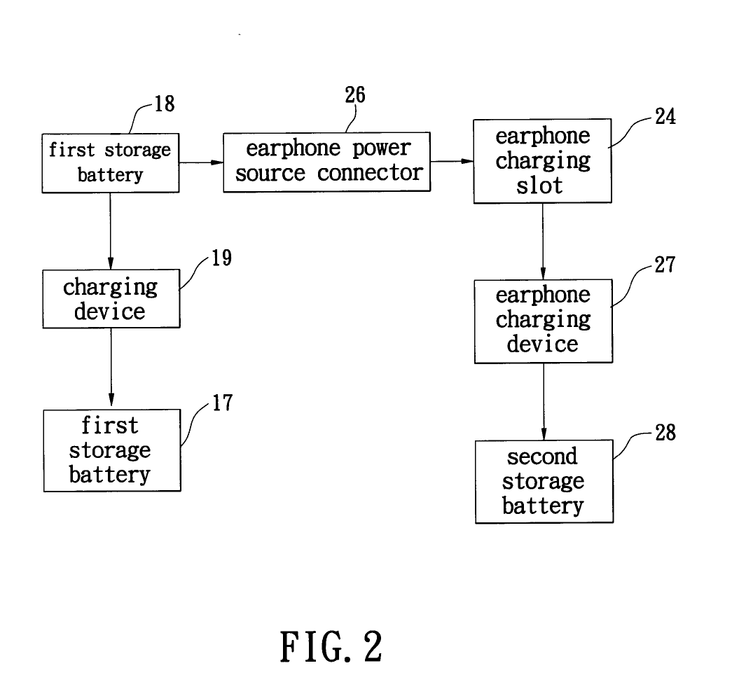

As shown in FIGS. 1 and 2, an accommodation device for a bluetooth earphone comprises a bluetooth communication apparatus 1 and a bluetooth earphone 2.

The bluetooth communication apparatus 1 comprises a shell 10 having a first groove 12 and a second groove 14. An earphone power source connector 26 is provided in the second groove 14. A charging slot 18 is connected on the shell 10, and is connected to a charging device 19 in the shell 10 and the earphone power source connector 26. A first storage battery 17 is placed in the first groove 12, and is connected to the charging device 19 via a power source connector 16 in the first groove 12. The first storage battery 17 is a Ni—Cd battery, a Ni-MH battery or a lithium battery.

The bluetooth earphone 2 is placed in the second groove 14 of the bluetooth communication apparatus 1, and comprises an earphone shell 22, an earphone charging slot 24 and a second storage battery 28. The earphone charging slot 24 is connected on the earphone shell 22, and is connected to an earphone charging device 27 in the earphone shell 22 and the earphone power source connector 26 in the bluetooth communication apparatus 1. The second storage battery 28 is placed in the earphone shell 22, and is connected to the earphone charging device 27. The second storage battery 28 is a Ni—Cd battery, a Ni-MH battery or a lithium battery.

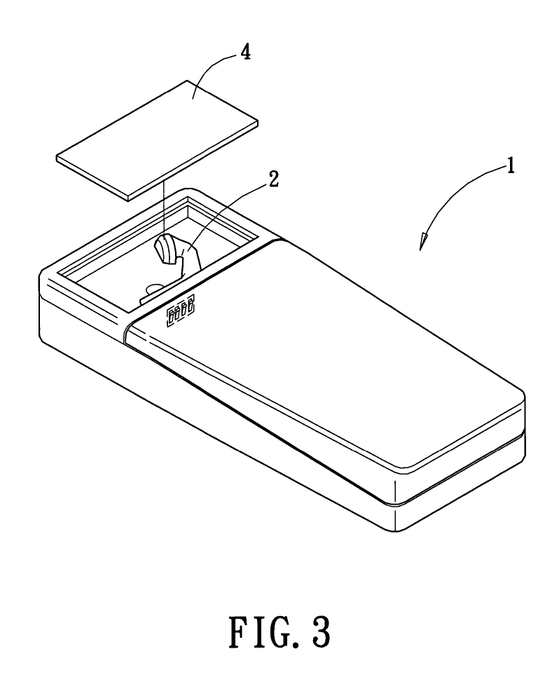

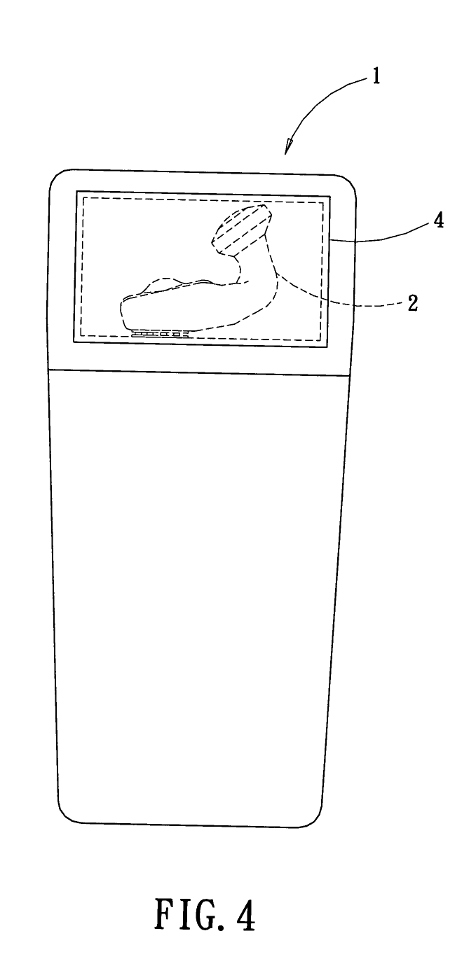

As shown in FIGS. 1, 3 and 4, the first storage battery 17 is placed in the first groove 12 of the bluetooth communication apparatus 1, and is shielded by a battery cover. The bluetooth earphone 2 is placed in the second groove 14 of the bluetooth communication apparatus 1. The earphone charging slot 24 is connected with the earphone power source connector 26 in the second groove 14. The bluetooth earphone 2 is shielded by a cover body 4. When the charging slot 18 of the bluetooth communication apparatus I is connected to a charger, the first storage battery 17 of the bluetooth communication apparatus 1 can be charged via the charging device 19. The bluetooth earphone 2 can also be connected with the earphone charging device 27 via the earphone power source connector 26 in the second groove 14 to charge the second storage battery 28.

To sum up, the present invention makes use of a bluetooth communication apparatus to provide a fixed placement space for a bluetooth earphone, hence solving the problem of easy loss of the bluetooth earphone in the prior art. Moreover, because the power sources of the bluetooth communication apparatus and the bluetooth earphone are connected together, when the bluetooth communication apparatus is being charged, the bluetooth earphone can be simultaneously charged, hence solving the prior art drawback of needing two charging cables.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. An accommodation device for a bluetooth earphone, the accommodation device comprising:
a bluetooth communication apparatus having a shell, said shell having a first groove and a second groove, said first groove being used for receiving a first storage battery; and
a bluetooth earphone received in said second groove of said bluetooth communication apparatus.

2. The accommodation device for a bluetooth earphone as claimed in claim 1, wherein a charging slot is further provided in said shell and is connected to a charging device.

3. The accommodation device for a bluetooth earphone as claimed in claim 1, wherein an earphone power source connector is provided in said second groove and is connected to a charging slot.

4. The accommodation device for a bluetooth earphone as claimed in claim 1, wherein said bluetooth earphone comprises:
an earphone shell;
an earphone charging slot arranged in said earphone shell and connected to an earphone charging device and an earphone power source connector in said bluetooth communication apparatus; and
a second storage battery arranged in said earphone shell and connected to said earphone charging device.

5. The accommodation device for a bluetooth earphone as claimed in claim 1, wherein said first storage battery is a Ni-CD battery, a Ni-MH battery or a lithium battery.

6. The accommodation device for a bluetooth earphone as claimed in claim 4, wherein said second secondary is a Ni-CD battery, a Ni-MH battery or a lithium battery.

7. The accommodation device for a bluetooth earphone as claimed in claim 4, wherein said bluetooth communication apparatus comprises a battery cover to shield said first groove.

8. The accommodation device for a bluetooth earphone as claimed in claim 4, wherein said bluetooth communication apparatus comprises a cover body to shield said second groove.
